(19) United States
(12) Patent Application Publication
(10) Pub. No.: US 2016/0236435 A1
(43) Pub. Date: Aug. 18, 2016

(54) DEVICE AND METHOD FOR PRESSING ORGANIC MATERIAL OUT OF WASTE

(71) Applicant: D TECHNOLOGIES HOLDING B.V.

(72) Inventor: Willem Jan OUDE GROTEBEVELSBORG, Ootmarsum (NL)

(21) Appl. No.: 15/027,885

(22) PCT Filed: Aug. 28, 2014
(86) PCT No.: PCT/NL2014/000026

§ 371 Date: Apr. 7, 2016

(30) Foreign Application Priority Data
Oct. 13, 2013 (NL) NL 1040442

(51) Int. Cl. B30B 9/30; B30B 9/06

(52) U.S. Cl. CPC B30B 9/3039; B30B 9/301; B30B 9/3014; B30B 9/06

(57) ABSTRACT

Device (100) for pressing organic material out of waste, comprising:—a pressing chamber (3) and a first pressing member (4) for compacting introduced waste;—a first feed opening (5) for feeding waste into the pressing chamber (4);—perforations (6) for allowing air, moisture and organic material pressed out of introduced waste to escape from the pressing chamber (3), which perforations (6) are arranged in a wall (9) of the pressing chamber (3) and debouch in a surface (7) bounding the pressing chamber (3); and—a discharge opening (8) for discharging from the pressing chamber (3) compacted waste from which air, moisture and organic material are at least partially removed and whereby the surface lies perpendicularly of the pressing direction of the first pressing member (4). Pressing perpendicularly of the surface (7) results in a more effective and efficient pressing. The device (100) preferably also comprises:—a second feed opening (2) for feeding waste into the device (100); and—an infeed chamber (13), which infeed chamber (13) is located between the first feed opening (5) and the second feed opening (2). A pre-compaction takes place during the displacement of waste fed into the infeed chamber (13) to the pressing chamber (3) via the first feed opening (5), this still further increasing the effectiveness, efficiency and yield of the pressing. Also method for pressing organic material out of waste by means of such a device.

### FIELD OF THE INVENTION

The invention relates to a device for pressing organic material out of waste, comprising:
a pressing chamber and a first pressing member for compacting introduced waste;
a first feed opening for feeding waste into the pressing chamber;
perforations for allowing air, moisture and organic material pressed out of introduced waste to escape from the pressing chamber, which perforations are arranged in a wall of the pressing chamber and debouch in a surface bounding the pressing chamber; and
a discharge opening for discharging from the pressing chamber compacted waste from which air, moisture and organic material are at least partially removed.

The invention also relates to a method for pressing organic material out of waste by means of such a device.

### BACKGROUND OF THE INVENTION

Household refuse consists mainly of packaging material; glass, paper, plastic and tin; food remnants; wastepaper; garden waste; and other waste such as broken lamps, empty batteries, broken toys and diverse other superfluous articles. Among other materials domestic waste comprises plastic, mainly PE, PP and PVC; organic material such as food remnants and garden waste; water present particularly in the organic material; paper, cardboard packaging, drink packs and old newspapers; metal such as tin and aluminium, but also for instance copper from appliances; glass such as broken glasses, jars and light bulbs; and textiles such as old clothing.

The following are often collected separately: paper and cardboard waste; glass waste; household hazardous waste (HHW or red waste); kitchen and garden waste (KGW or green waste); plastic bottles, metal and drink packaging (PMD or blue waste); textile waste; small appliances and electric household equipment (white goods), sound and vision electronics (brown goods) and ICT equipment (grey goods); and residual waste (grey waste), this being all other domestic waste. Paper and cardboard waste, glass waste, HHW, KGW, PMD, textile waste, and white, brown and grey goods can be wholly or partially recycled. Paper and cardboard waste and KGW are sometimes also incinerated. The residual waste (grey waste) can be incinerated or dumped. It can then for instance first be shredded, wherein waste bags are opened and the residual waste is reduced in size, after which for instance ferromagnetic materials are removed with a magnet and light plastic objects are blown out of the waste with air. The residual waste and KGW can for instance also be put together and composted.

The organic material can also be processed by digestion. For this purpose it must first be separated from the waste, household waste or residual waste. A suitable method herefor is pressing. The waste is fed here into a pressing chamber and compacted by means of a pressing member, for instance an auger or a plunger. At a sufficiently high pressure the cell walls break and the moisture enclosed in the cells is released. The consistency of the organic material hereby changes from more solid to more pasty and more liquid. Air, moisture and organic material leave the pressing chamber via discharge channels, gaps or perforations provided for the purpose. The remaining compacted material is removed from the pressing chamber by means of a method suitable for the purpose.

Described in NL7203727A is an example of pressing of organic material from waste with a plunger as pressing member, wherein the waste is fed by means of the same plunger into a pressing chamber and the remaining material is also removed again by means of this same plunger from the pressing chamber via a tube with an open outer end. The maximum pressing force is however limited here and the plunger always has to make a relatively large stroke. Found in EP0091365A1 is another example of pressing of organic material from waste with a first plunger as pressing member with which the waste is again also fed into a pressing chamber, and wherein the remaining material is now removed from the pressing chamber by means of a second plunger via a discharge opening provided for this purpose. Here too, the first plunger always has to make a relatively large stroke. The construction of the device, and in particular the relative placing of the components thereof, also limits the maximum pressing forces. U.S. Pat. No. 5,146,848A describes a pressing device for recovering liquid present in containers, comprising two plungers lying mutually in line and operating in mutually opposite directions. Both plungers have to be able here to supply the great force required for pressing out the relevant material, and this with a relatively large stroke, which makes the device costly and complex. U.S. Pat. No. 6,178,882B1 describes a device with the same function, though now with two plungers moving mutually perpendicularly of each other. The first plunger again compacts the relevant material and the waste is again fed with this first plunger into a pressing chamber while the compacted material is again removed from the pressing chamber by means of the second plunger. It is here also the case that the first plunger always has to make a relatively large stroke, and that the construction of the device, and particularly the relative placing of the components thereof, limits the maximum pressing forces.

Said known devices thus have in each case one or both of the following drawbacks: (1) the plunger which compacts the material, and so has to deliver great forces and therefore takes a heavy form, must make a relatively large stroke, this making the device costly and complex and limiting the processing speed, and (2) the construction of the device, and in particular the relative placing of the components thereof, limits the maximum pressing forces. It is more generally the case that known devices and methods for pressing organic material out of waste, household waste or residual waste, also have many other drawbacks in respect of effectiveness, efficiency and yield, robustness, durability, energy consumption, susceptibility to malfunction, wear, maintenance and the costs of production, exploitation and maintenance. The present invention now provides a solution which does not have the stated drawbacks, or at least does so to lesser extent.

### SUMMARY OF THE INVENTION

The invention provides a device as according to claim 1 and a method as according to claim 16. The term ‘perpendicularly’ is understood in the context of the invention to mean ‘at least substantially perpendicularly’. Pressing perpendicularly of the surface results in a more effective and efficient pressing. Perforations can also be arranged here in the first pressing member. The effectiveness, the efficiency and the yield of the pressing can be increased still further by arranging the perforations in both the fixed wall and the first pressing member. The first pressing member preferably comprises a first plunger. Using a plunger, in contrast to for instance an auger, the pressure in the pressing chamber and the compacted material can be properly controlled and a high pressure can be readily realized.

The device preferably also comprises a second pressing member, more preferably a second plunger, for discharging compacted waste from the pressing chamber through the discharge opening. The pressing direction of the second pressing member preferably lies perpendicularly of the pressing direction of the first pressing member and the cross-section of the second pressing member is the same as the cross-section of the discharge opening.

The term ‘the same’ is understood in the context of the invention to mean ‘at least substantially the same’. The term ‘cross-section’ is understood here to mean ‘the active cross-section perpendicularly of the direction of movement’. It is thus found that the discharge of compacted material can take place simply and optimally with the smallest possible chance of malfunctions, for instance due to larger pieces of solid material becoming jammed in the device.

The device preferably also comprises:
a second feed opening for feeding waste into the device; and
an infeed chamber, which infeed chamber is located between the first feed opening and the second feed opening.

In a first extreme position of the first pressing member the infeed chamber can be situated here between the pressing surface of the first pressing member and the first feed opening. Waste fed into the infeed chamber can then be displaced by means of the first pressing member via the first feed opening to the pressing chamber and there subsequently compacted by means of the first pressing member. In a first extreme position of the second pressing member the infeed chamber can also be situated between the pressing surface of the second pressing member and the first feed opening. Waste fed into the infeed chamber can then be displaced by means of the second pressing member via the first feed opening to the pressing chamber and there subsequently compacted by means of the first pressing member. The term ‘pressing surface’ is understood in the context of the invention to mean ‘the part of the periphery exerting pressure on the relevant material during pressing or displacement’. ‘Between the pressing surface of a pressing member and a feed opening’ is understood here to mean ‘between a first plane in which the pressing surface lies and a second plane in which the feed opening lines’. A pre-compaction takes place during the displacement of waste fed into the infeed chamber to the pressing chamber via the first feed opening, this still further increasing the effectiveness, efficiency and yield of the pressing.

### BRIEF DESCRIPTION OF THE DRAWINGS

The invention is elucidated hereinbelow on the basis of non-limitative exemplary embodiments. More or less schematically in the drawings:

FIG. 1 shows a horizontal longitudinal section of a first exemplary embodiment of a device according to the invention;

FIG. 2 shows a perspective view of a second exemplary embodiment of a device according to the invention;

FIG. 3 is a top view of the device shown in FIG. 2;

FIG. 4 is a vertical section of the device shown in FIG. 2 along the plane A-A;

FIG. 5 is a vertical section of the device shown in FIG. 2 along the plane B-B;

FIG. 6 shows a perspective view of a third exemplary embodiment of a device according to the invention;

FIG. 7 is a top view of the device shown in FIG. 6,

FIG. 8 is a side view of the device shown in FIG. 6;

FIG. 9 is a vertical section of the device shown in FIG. 6 along the plane B-B;

FIG. 10 shows a perspective view of a fourth exemplary embodiment of a device according to the invention;

FIG. 11 is a top view of the device shown in FIG. 10;

FIG. 12 is a vertical section of the device shown in FIG. 10 along the plane A-A; and

FIG. 13 is a vertical section of the device shown in FIG. 10 along the plane B-B.

### EXEMPLARY EMBODIMENTS

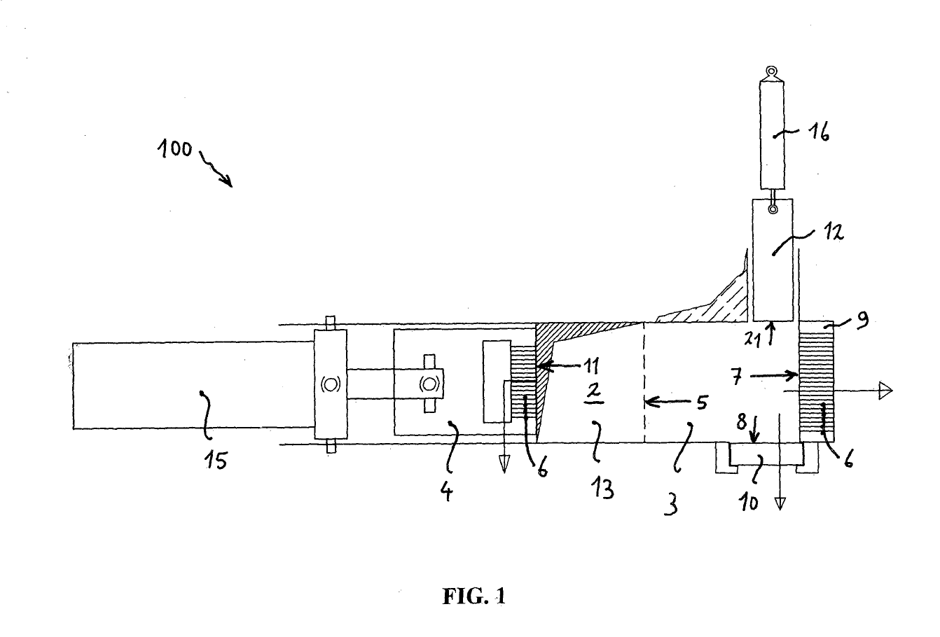

The device (100) shown in FIG. 1 comprises a second feed opening (2) for feeding waste into device (100), an infeed chamber (13), a pressing chamber (3) and a first pressing member, here a first plunger (4), for compacting introduced waste, and a first feed opening (5) for feeding waste into pressing chamber (3). In order to allow air, moisture and organic material pressed out of introduced waste to escape from pressing chamber (3) perforations (6) are arranged in a wall (9) of pressing chamber (3). Perforations (6) debouch in a surface (7) bounding pressing chamber (3). Characteristic is the position of this surface (7) perpendicularly of the pressing direction of first pressing member (4). Perforations (6) are also arranged in first plunger (4).

First plunger (4) is movable between two extreme positions by means of a drive, here a first hydraulic cylinder (15). In the first extreme position (shown in FIG. 1) infeed chamber (13) is situated between pressing surface (11) of first plunger (4) and first feed opening (5). The waste to be compacted can now be fed via the second feed opening (2) into device (100). First plunger (4) can be moved (to the right in FIG. 1) to the second extreme position in which pressing surface (11) is situated in pressing chamber (3) (not shown) and first plunger (4) closes second feed opening (2). In this movement the waste to be compacted is fed into pressing chamber (3) via first feed opening (5), pre-compacted and further compacted in pressing chamber (3).

Device (100) also comprises a discharge opening (8) for discharging compacted waste from pressing chamber (3). Discharge opening (8) can be closed by means of a first door, here a sliding door (10). Device (100) also comprises a second pressing member, here a second plunger (12), movable by means of a drive, here a second hydraulic cylinder (16), for discharging compacted waste out of pressing chamber (3) through discharge opening (8). The pressing direction of second plunger (12) lies perpendicularly here of the pressing direction of first plunger (4). Second plunger (12) is movable between two extreme positions, a first extreme position (shown in FIG. 1) in which pressing surface (21) is situated just outside pressing chamber (3) and bounds pressing chamber (3), and a second extreme position (not shown) wherein pressing surface (21) is situated at the position of discharge opening (8). In the movement from the first extreme position to the second extreme position material compacted in pressing chamber (3), following opening of sliding door (10), is discharged from pressing chamber (3) via discharge opening (8).

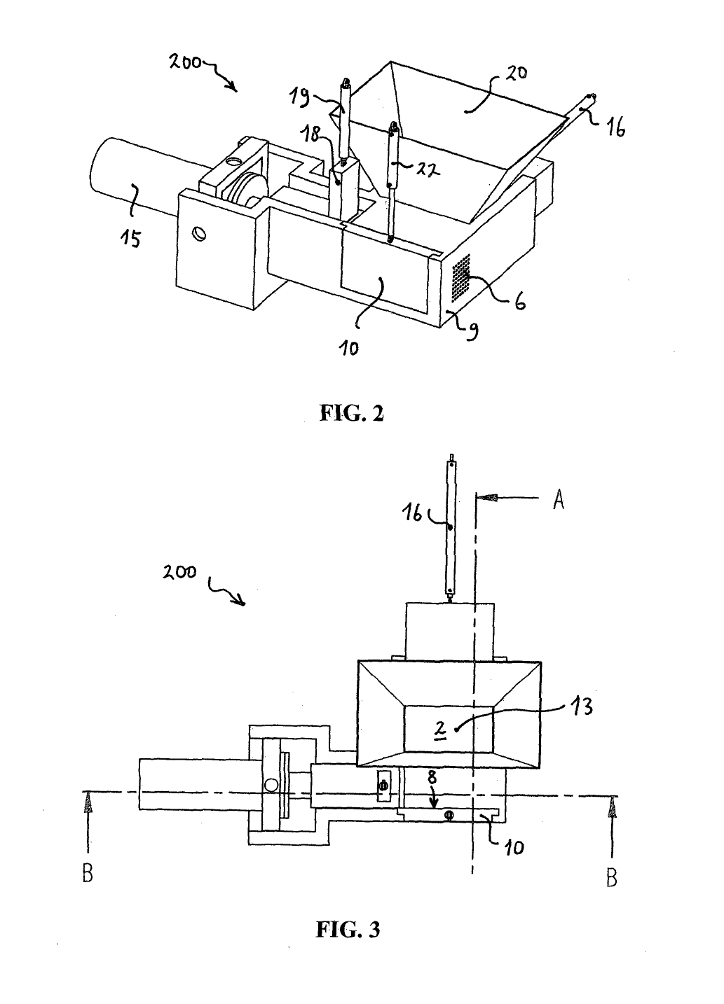

The device (200) shown in FIGS. 2-5 again comprises a second feed opening (2), provided here with a hopper (20), for feeding waste into device (200), an infeed chamber (13), a pressing chamber (3) and a first pressing member, here again a first plunger (4), for compacting introduced waste, a first feed opening (5) for feeding waste into pressing chamber (3), and a second pressing member, here again a second plunger (12), for discharging compacted waste from pressing chamber (3) through a discharge opening (8). The pressing direction of second plunger (12) again lies perpendicularly here of the pressing direction of first plunger (4). In order to allow air, moisture and organic material pressed from introduced waste to escape from pressing chamber (3) perforations (6) are once again arranged in a wall (9) of pressing chamber (3) and in first plunger (4). Second feed opening (2), first feed opening (5) and infeed chamber (13) are however now situated at other locations.

First plunger (4) is again movable by means of a drive, here again a first hydraulic cylinder (15), again between two extreme positions. In the first extreme position (shown in FIG. 5) the pressing surface (11) is now situated just outside the pressing chamber (3) and pressing surface (11) bounds pressing chamber (3). In the second extreme position (not shown) the pressing surface (11) is again situated inside pressing chamber (3). In the movement from the first extreme position to the second extreme position the introduced waste is compacted in pressing chamber (3). The stroke made my first plunger (4) is now minimal, which has advantages in respect of for instance simplicity of construction, processing capacity, wear and the space and energy required.

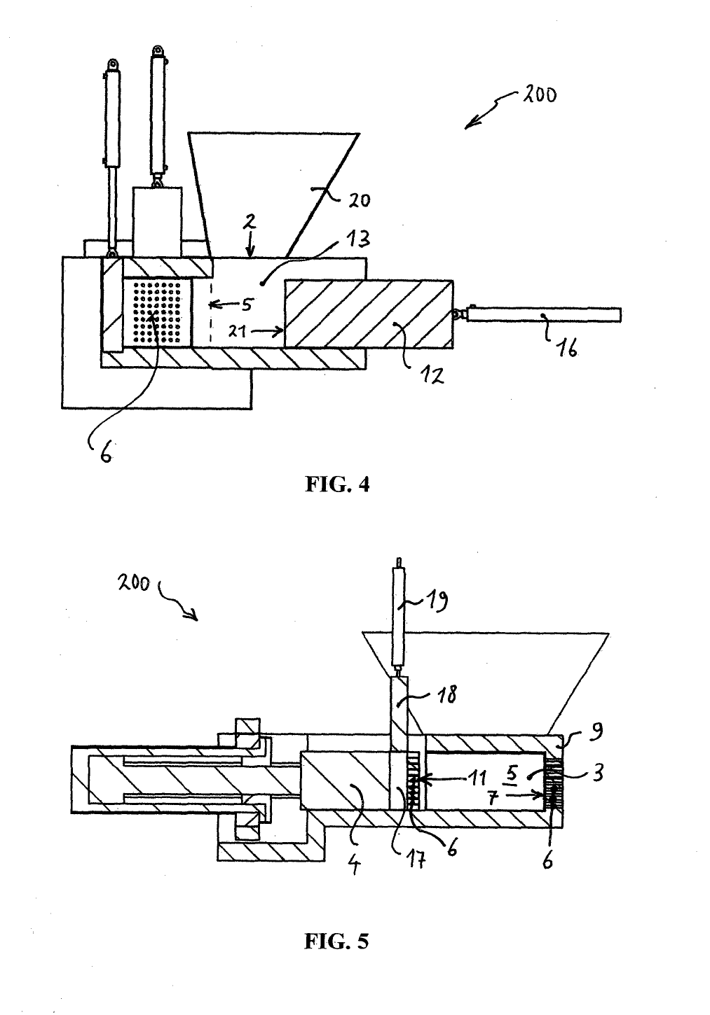

Discharge opening (8) can again be closed by means of a first door, here again a sliding door (10), driven here by means of a third hydraulic cylinder (22). Second plunger (12) is again movable between two extreme positions. In a first extreme position (shown in FIG. 4) infeed chamber (13) is now situated between pressing surface (21) of second plunger (12) and first feed opening (5). The waste to be compacted can again now be fed via second feed opening (2) into device (200). In an intermediate position between the two extreme positions (not shown) pressing surface (21) is situated at the position of first feed opening (5). In the movement from the first extreme position to the intermediate position waste to be compacted is now carried by means of second plunger (12) via first feed opening (5) into pressing chamber (3) and thereby pre-compacted. The introduced waste can now be compacted by means of first plunger (4) wherein pressing surface (21) of second plunger (12) bounds pressing chamber (3). In the second extreme position (not shown) of second plunger (12) the pressing surface (21) is again situated at the position of discharge opening (8). In the movement from the intermediate to the second extreme position material compacted in pressing chamber (3) is once again discharged via discharge opening (8) out of pressing chamber (3) following opening of sliding door (10). The position of second plunger (12) in the intermediate position has to be well-defined. This is possible for instance by fixing second plunger (12) in this intermediate position within the applicable tolerances by means of a locking (not shown) provided for this purpose, for instance in the form of pins and receiving spaces co-acting therewith. The extreme positions of plungers (4,12) are in principle easier to define, for instance by having the plungers (4,12) come up against stops provided for this purpose in the extreme positions, this in a manner as will be apparent to a skilled person.

The cross-section, i.e. the active cross-section perpendicularly of the direction of movement, of second plunger (12) is the same as the cross-section of discharge opening (8). All waste compacted in pressing chamber (3) can in principle thus be removed from pressing chamber (3) via discharge opening (8) by means of second plunger (12) when sliding door (10) is opened and first plunger (4) is in its first extreme position (as shown in FIG. 5). There is very little chance here of objects becoming jammed in device (200) or pressing chamber (3).

Device (200) also comprises a provision, here a slide (18) driven by means of a fourth hydraulic cylinder (19), for discharging pressed-out organic material, present here in a space (17) provided for this purpose in first plunger (4). Device (200) can comprise more of such provisions (not shown), for instance also for the purpose of removing pressed-out material in the vicinity of the perforated wall (9).

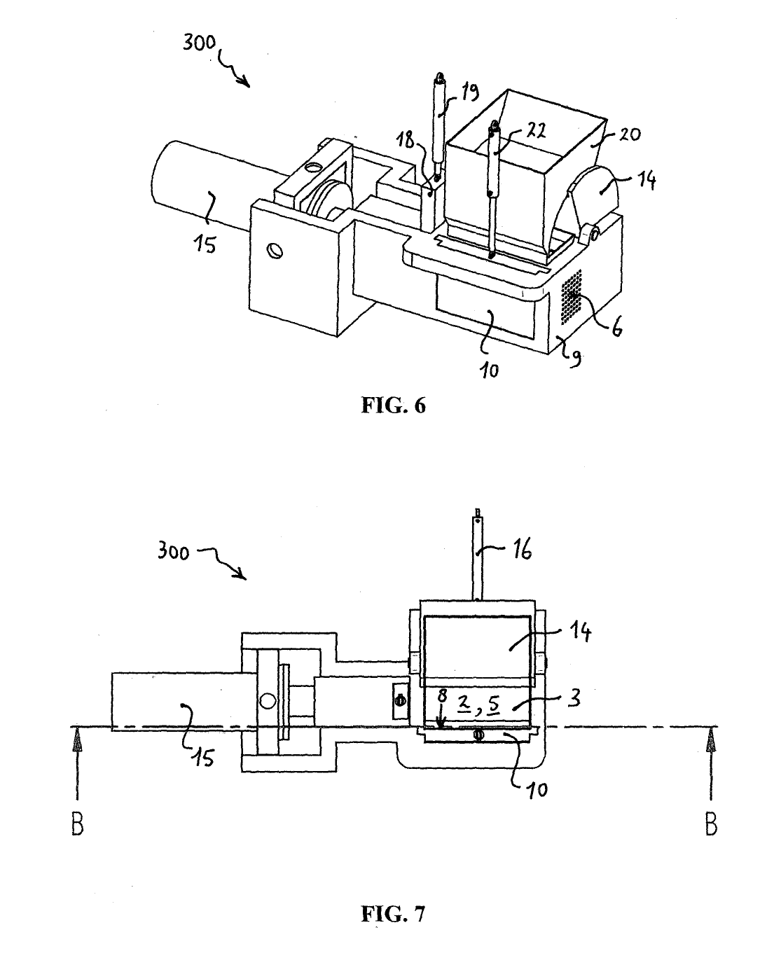

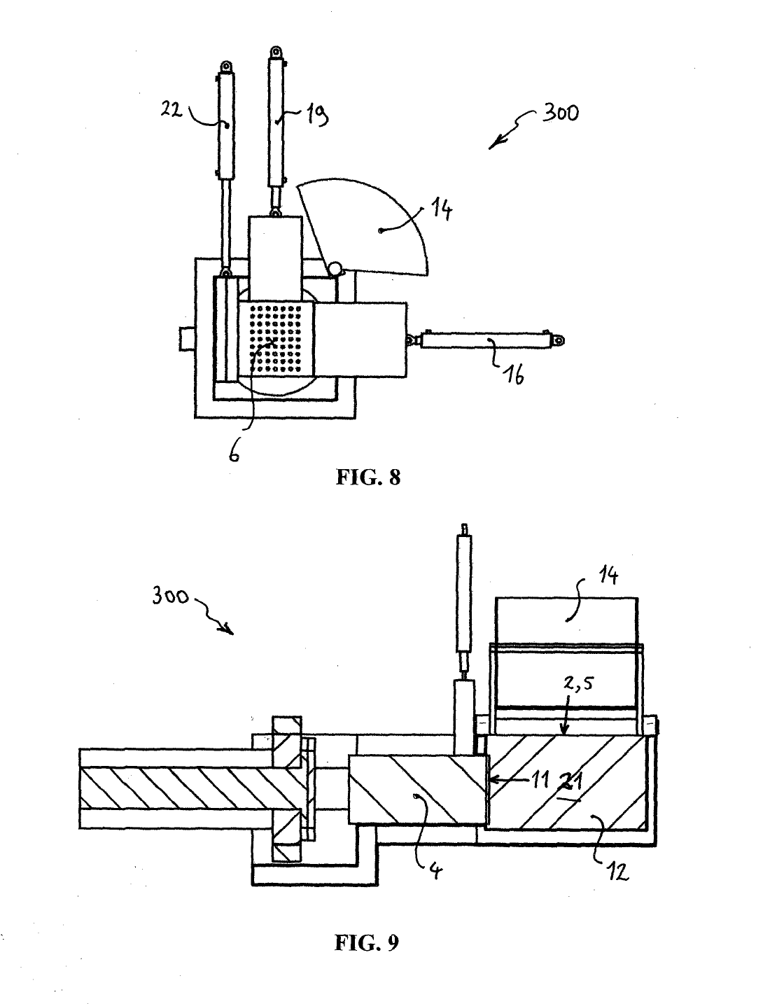

Device (300) shown in FIGS. 6-9 once again comprises the same components as devices (100;200) shown in FIGS. 1-5. Second feed opening (2) and first feed opening (5) now however coincide and are now situated at another location, i.e. immediately above pressing chamber (3), and bound pressing chamber (3). It could also be stated that the volume of the infeed chamber is now zero. The strokes made by first plunger (4) and second plunger (12) are now both minimal, which again has advantages, for instance in respect of simplicity of construction, processing capacity, wear and the space and energy required. Device (300) now also comprises a second door for opening and closing the combined feed opening (2,5), here a pivoting door (14), although this can for instance again be a sliding door. A pivoting door is generally recommended because parts protruding outside pressing chamber (3) are hereby pushed inward during closing of door (14) and cannot therefore become jammed during the movement of second plunger (12). A partial pre-compaction also takes place here.

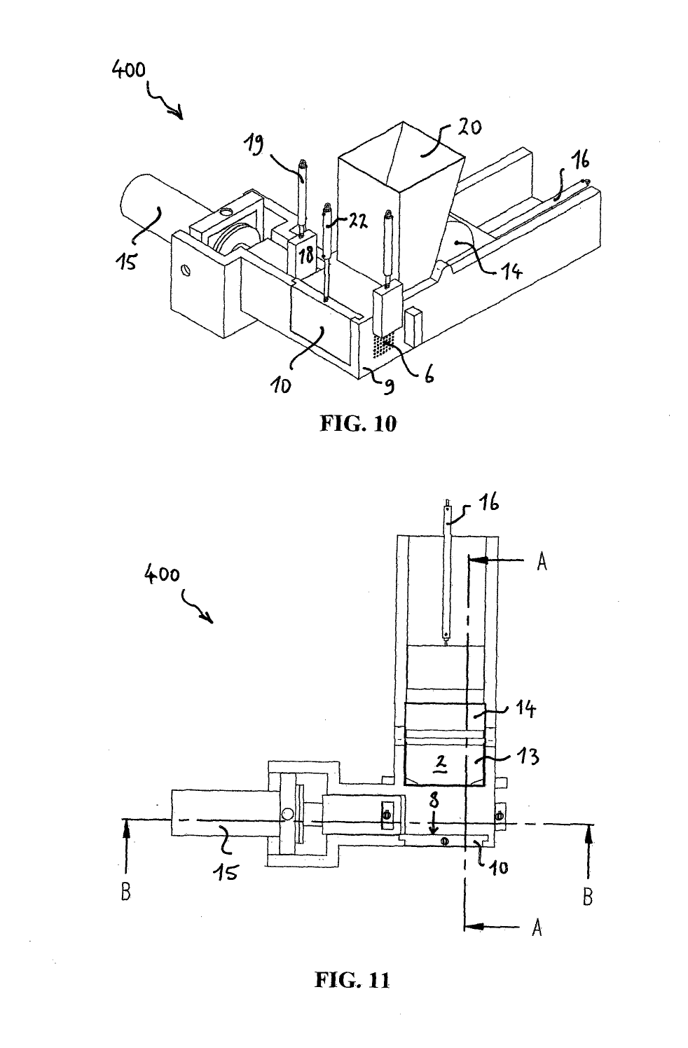

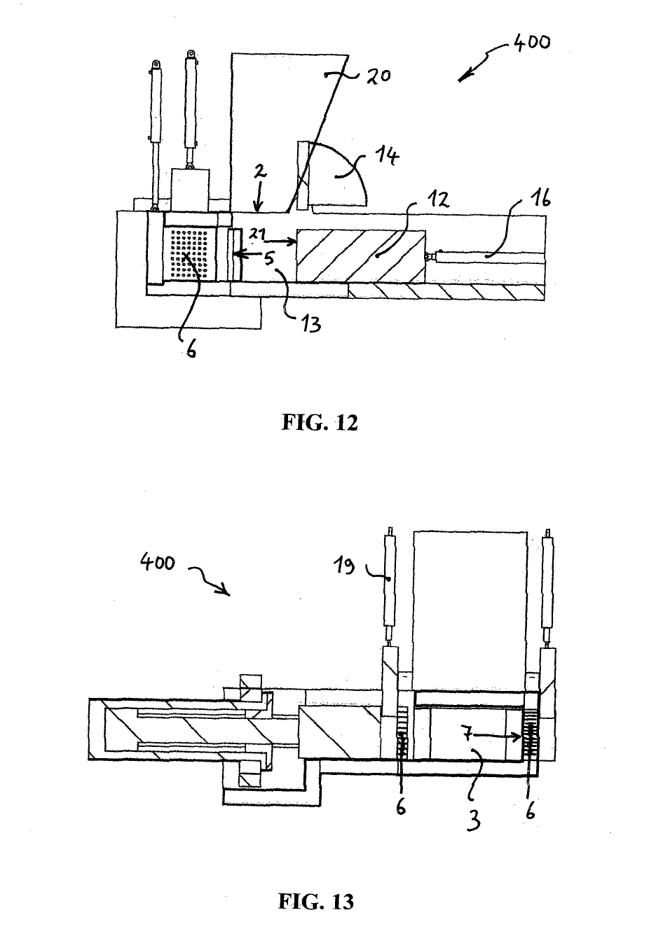

Device (400) shown in FIGS. 10-13 again comprises the same components as devices (100;200;300) shown in FIGS. 1-9. Second feed opening (2), first feed opening (5) and infeed chamber (13) are again now situated at other locations. In the first extreme position (shown in FIG. 12) infeed chamber (13) is now situated between pressing surface (21) of second plunger (12) and first feed opening (5). By means of second plunger (12) the waste fed via second feed opening (2) into infeed chamber (13) is fed through further to pressing chamber (3) via first feed opening (5), and again pre-compacted here. Device (300) also again comprises a second door, now for opening and closing the second feed opening (2), here again a pivoting door (14). During closing of the door (14) parts protruding outside infeed chamber (13) are again pushed inward so that they cannot become jammed during the movement of second plunger (12). A partial pre-compaction again also takes place here.

In a device (200;400) according to the invention comprising an infeed chamber (13) located between second feed opening (2) and the first feed opening the waste is not fed directly into pressing chamber (3) but via infeed chamber (13). In addition to the stated advantages of pre-compaction and limiting the stroke required by first plunger (4), this also has structural advantages. The walls of pressing chamber (3) then have fewer openings, whereby they can better absorb the great forces exerted thereon.

Operation with a device (100;200;300;400) according to the invention can take place as follows. Perforations (6) have for instance a size of 4 to 8 mm. When during pressing a desired final pressure of for instance between 200-300 bar has been reached, first plunger (4) can be moved back. Discharge opening (8) can subsequently be opened by sliding away the sliding door (10) present in a side wall of pressing chamber (3). The remaining solid material can then be pressed out of pressing chamber (3) from an opposite side wall of pressing chamber (3) by means of second plunger (12). Plungers (4,12) then return to their rest positions (first extreme positions) and sliding door (10) is closed for the following cycle. The organic material pressed through perforations (6) is collected and carried away, optionally using additional plungers or slides.

Owing to the relatively high pressure, whereby the cell walls break and the organic material becomes more pasty and fluid, but also due to pressing through the relatively small perforations (6), very few interfering substances will be present in the pressed-out material. Stainless steel objects, such as knives and forks, which cannot be removed in a magnetic pre-processing, will thus not appear in the pressed-out material. The pressed-out material will also be greatly reduced in size as it passes through the relatively small perforations, and the proportion of glass and sand will decrease, as will the proportion of plastics. As a result of all this it will be possible to digest the pressed-out material much more easily, completely and rapidly, wherein downtime caused by interfering substances is limited to a minimum.

What remains in the pressing chamber after pressing is largely free of organic material and moisture. The remaining material has a greatly reduced moisture content, whereby the calorific value is greatly increased. Because the remaining material is relatively dry, it can also be further separated more easily since dry material adheres less than moist material. Owing to the relatively simple construction with a pressing chamber which is wholly closed during pressing and with few moving parts, the device is robust. It has also become easier to replace wearing parts, such as the perforated parts. The drives and guides of the plungers are loaded less than in known devices.

It will be apparent that the invention is not limited to the shown and described exemplary embodiments but that diverse variants which will be obvious to a skilled person are possible within the scope of the invention. In addition to being used for pressing organic material out of waste, the invention can also be applied for pressing another softer, more deformable or liquid fraction from a mixture also comprising a more solid and less deformable fraction.

1. Device for pressing organic material out of waste, comprising:
a pressing chamber and a first pressing member for compacting introduced waste;
a first feed opening for feeding waste into the pressing chamber;
perforations for allowing air, moisture and organic material pressed out of introduced waste to escape from the pressing chamber, which perforations are arranged in a wall of the pressing chamber and debouch in a surface bounding the pressing chamber; and
a discharge opening for discharging from the pressing chamber compacted waste from
which air, moisture and organic material are at least partially removed, characterized in that the surface lies perpendicularly of the pressing direction of the first pressing member.

2. Device as claimed in claim 1, characterized in that perforations for allowing air, moisture and organic material pressed out of introduced waste to escape from the pressing chamber are also arranged in the first pressing member.

3. Device as claimed in claim 1, characterized in that the first pressing member comprises a first plunger.

4. Device as claimed in claim 1, characterized in that the device also comprises:
a second feed opening for feeding waste into the device; and
an infeed chamber, which infeed chamber is located between the first feed opening and the second feed opening.

5. Device as claimed in claim 4, characterized in that in a first extreme position of the first pressing member the infeed chamber is situated between the pressing surface of the first pressing member and the first feed opening.

6. Device as claimed in claim 1, characterized in that the device also comprises a second pressing member for discharging compacted waste out of the pressing chamber through the discharge opening.

7. Device as claimed in claim 6, characterized in that the second pressing member comprises a second plunger.

8. Device as claimed in claim 6, characterized in that the pressing direction of the second pressing member lies perpendicularly of the pressing direction of the first pressing member.

9. Device as claimed in claim 6, characterized in that the cross-section of the second pressing member is the same as the cross-section of the discharge opening.

10. Device as claimed in claim 6, wherein the device also comprises:
a second feed opening for feeding waste into the device; and
an infeed chamber, which infeed chamber is located between the first feed opening and the second feed opening,
characterized in that in a first extreme position of the second pressing member the infeed chamber is situated between the pressing surface of the second pressing member and the first feed opening.

11. Device as claimed in claim 6, characterized in that the device also comprises a first door for opening and closing the discharge opening.

12. Device as claimed in claim 11, characterized in that the first door comprises a sliding door with a sliding direction perpendicularly of the pressing direction of the second pressing member.

13. Device as claimed in claim 1, characterized in that the device also comprises a second door for opening and closing the first feed opening.

14. Device as claimed in claim 4, characterized in that the device also comprises a second door for opening and closing the second feed opening.

15. Device as claimed in claim 13, characterized in that the second door comprises a pivoting door.

16. Method for pressing organic material out of waste by means of a device comprising:
a pressing chamber and a first pressing member for compacting introduced waste;
a first feed opening for feeding waste into the pressing chamber;
perforations for allowing air, moisture and organic material pressed out of introduced waste to escape from the pressing chamber, which perforations are arranged in a wall of the pressing chamber and debouch in a surface bounding the pressing chamber; and
a discharge opening for discharging from the pressing chamber compacted waste from which air, moisture and organic material are at least partially removed, the method comprising of:
feeding waste via the first feed opening into the pressing chamber;
compacting introduced waste in the pressing chamber by means of the first pressing member;
allowing air, moisture and organic material pressed out of introduced waste to escape from the pressing chamber via the perforations; and
discharging compacted waste from the pressing chamber via the discharge opening, characterized in that pressing takes place perpendicularly of the surface by means of the first pressing member.

17. Method as claimed in claim 16, wherein the device also comprises:
a second feed opening for feeding waste into the device; and
an infeed chamber, which infeed chamber is located between the first feed opening and the second feed opening, which infeed chamber in a first extreme position of the first pressing member is situated between the pressing surface of the first pressing member and the first feed opening, characterized in that the method also comprises of:
feeding waste into the infeed chamber via the second feed opening; and
displacing waste fed into the infeed chamber to the pressing chamber via the first feed opening by means of the first pressing member.

18. Method as claimed in claim 16, wherein the device also comprises:
a second pressing member for discharging compacted waste from the pressing chamber through the discharge opening;
a second feed opening for feeding waste into the device; and
an infeed chamber, which infeed chamber is located between the first feed opening and the second feed opening, and wherein in a first extreme position of the second pressing member the infeed chamber is situated between the pressing surface of the second pressing member and the first feed opening,
characterized in that the method also comprises of:
feeding waste into the infeed chamber via the second feed opening; and
displacing waste fed into the infeed chamber to the pressing chamber via the first feed opening by means of the second pressing member.
